(19) United States
(12) Patent Application Publication
(10) Pub. No.: US 2021/0174007 A1
(43) Pub. Date: Jun. 10, 2021

(54) CREATION APPARATUS AND NON-TRANSITORY COMPUTER READABLE MEDIUM

(71) Applicant: FUJI XEROX CO., LTD., Tokyo (JP)

(72) Inventor: Takuya HONDA, Kanagawa (JP)

(73) Assignee: FUJI XEROX CO., LTD., Tokyo (JP)

(21) Appl. No.: 16/850,124

(22) Filed: Apr. 16, 2020

(30) Foreign Application Priority Data
Dec. 9, 2019 (JP) 2019-222406

(51) Int. Cl. G06F 40/174; G06F 16/9535

(52) U.S. Cl. CPC G06F 40/174; G06F 16/9535

(57) ABSTRACT

A creation apparatus includes a processor configured to retrieve, from a retrieval destination linked with a service, activity information on a user who uses the service in which a profile of the user is registered, and create, in accordance with the activity information, profile information to be included in the profile.

### CROSS-REFERENCE TO RELATED APPLICATIONS

This application is based on and claims priority under 35 USC 119 from Japanese Patent Application No. 2019-222406 filed Dec. 9, 2019.

### BACKGROUND

### (i) Technical Field

The present disclosure relates to a creation apparatus and a non-transitory computer readable medium.

### (ii) Related Art

Japanese Unexamined Patent Application Publication No. 2012-168653 discloses an information providing system that provides information to users. The information providing system includes a unit that periodically delivers an enquiry to a terminal of an active user who is accessing the information providing system and retrieves an answer to the enquiry, a unit that saves on a database the retrieved answer on a per user basis, a unit that creates a profile of each user in accordance with the answers saved on the database, a unit that calculates a similarity between the profiles of the users, a unit that selects another user with a profile having a higher similarity to the profile of the active user and transmits information on the selected user to the terminal of the active user, and a unit that transmits, in response to a request from the active user, the answers of the other users saved on the database to the terminal of the active user.

Japanese Unexamined Patent Application Publication No. 2008-225879 discloses a user preference information processing method of processing preference information on a user on a user terminal connected to a network. The preference information processing method includes analyzing with a web page analyzing unit in the user terminal a web page that a user browses via the network, automatically learning with a user preference learning unit in the user terminal the preference of the user through the results of analysis, creating and/or updating with a profile card recording unit in the user terminal a profile card indicating the preference of the user through the results of learning.

Japanese Unexamined Patent Application Publication No. 2012-226741 discloses a profile creating apparatus. The profile creation apparatus includes a registration unit that registers a user together with data on a first account in a social networking system (SUNS) and data on a second account in the SNS, a first acquisition unit that analyzes the data on the first account, a second acquisition unit that analyzes the data on the second accounts of all users in the SNS, a first relevant user identifying unit that identifies a first relevant user, an extraction unit that extracts data on an account of another user in accordance with the data on the second account, a determination unit that analyzes the extracted data on the account and determines whether a cooperating account is present in the SNS, a second relevant user identifying unit that identifies a second relevant user, and a user profile creating unit that analyzes data on the accounts of the first relevant user and the second relevant user and creates the profile of the user.

In service, such as matching service, profile information is registered. A user may be involved in entering the profile information and entering the profile information is typically time consuming.

### SUMMARY

Aspects of non-limiting embodiments of the present disclosure relate to saving more time for a user to enter profile information than when the configuration described below is not employed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a creation apparatus. The creation apparatus includes a processor configured to retrieve, from a retrieval destination linked with a service, activity information on a user who uses the service in which a profile of the user is registered and the processor is also configured to create, in accordance with the activity information, profile information to be included in the profile.

### BRIEF DESCRIPTION OF THE DRAWINGS

Exemplary embodiments of the present disclosure will be described in detail based on the following figures, wherein:

FIG. 1 illustrates a configuration of an information processing system of a first exemplary embodiment;

FIG. 2 schematically illustrates a display screen displaying a profile of the first exemplary embodiment;

FIG. 3 is a block diagram of a hardware configuration of a server of the first exemplary embodiment;

FIG. 4 is a functional block diagram illustrating the server of the first exemplary embodiment;

FIG. 5 is a flowchart illustrating a creating process performed by the server of the first exemplary embodiment;

FIG. 6 schematically illustrates the server of the first exemplary embodiment that creates profile information in accordance with activity information retrieved from a social networking system (SNS);

FIG. 7 schematically illustrates the server of the first exemplary embodiment that improves a blank entry item in the created profile information;

FIG. 8 schematically illustrates the server apparatus of the first exemplary embodiment that improves an insufficient entry item by linking the created profile information to the entered profile information;

FIG. 9 schematically illustrates the server apparatus of the first exemplary embodiment that improves an inconsistent entry item by substituting the created profile information;

FIG. 10 is a functional block diagram illustrating a server of a second exemplary embodiment;

FIG. 11 is a flowchart illustrating a creation process performed by the server of the second exemplary embodiment;

FIG. 12 illustrates the server of the second exemplary embodiment that creates the profile information in accordance with the activity information retrieved from a management service;

FIG. 13 is a functional block diagram illustrating a server of a third exemplary embodiment;

FIG. 14 is a flowchart illustrating a creation process performed by the server of the third exemplary embodiment; and

FIG. 15 illustrates the server of the third exemplary embodiment that displays the created profile information together with information that indicates that the profile information is a piece of created information.

### DETAILED DESCRIPTION

Embodiments of the disclosure are described with reference to the drawings.

### First Exemplary Embodiment

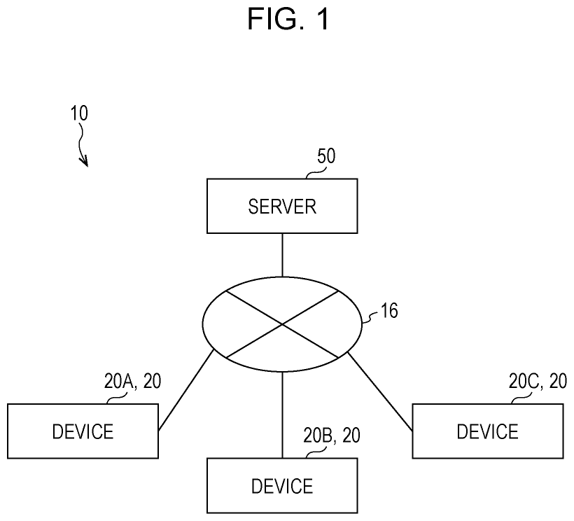

An information processing system 10 of the first exemplary embodiment is described below. FIG. 1 schematically illustrates the configuration of the information processing system 10.

The information processing system 10 includes a server 50 and multiple devices 20 as illustrated in FIG. 1. Specifically, in the information processing system 10, a user registers a profile to the server 50 via the device 20.

In the information processing system 10, a user registers a profile in the server 50, another user views the profile via the device 20, the two users may then get acquainted and keep in touch with each other. The users herein refer all users who use the information processing system 10. The users thus include users who are registered in the information processing system 10 (the server 50) and users who are not registered in the information processing system 10.

The server 50 and devices 20 are communicably interconnected to each other via a radio communication network 16, such as the Internet. FIG. 1 illustrates three devices 20A, 20B, and 20C as the devices 20 but the number of devices is not limited to any particular value. Each of the devices 20A, 20B, and 20C is representatively referred to as the device 20.

The device 20 is a terminal used by each user. Specifically, the device 20 is used when the user uses a service provided by the server 50. The device 20 may be a personal computer, tablet computer, smart phone, or cellular phone.

The server 50 is an example of a creation apparatus. The server 50 provides to the user a service in which a profile of the user is registered via the device 20. Specifically, the server 50 causes a profile registered by a user to be viewed by another user via the device 20 and thus provides a service to provide an opportunity for the users to get acquainted and keep in touch with each other. Such services are called matching services and include business matching service for matching job seekers with recruiters of companies and relationship matching service. Services provided by the server 50 are referred to as “provided services”.

The server 50 includes a medium (such as a web page) through which a user may view a profile registered by another user via the device 20. Each user may access the medium via the device 20.

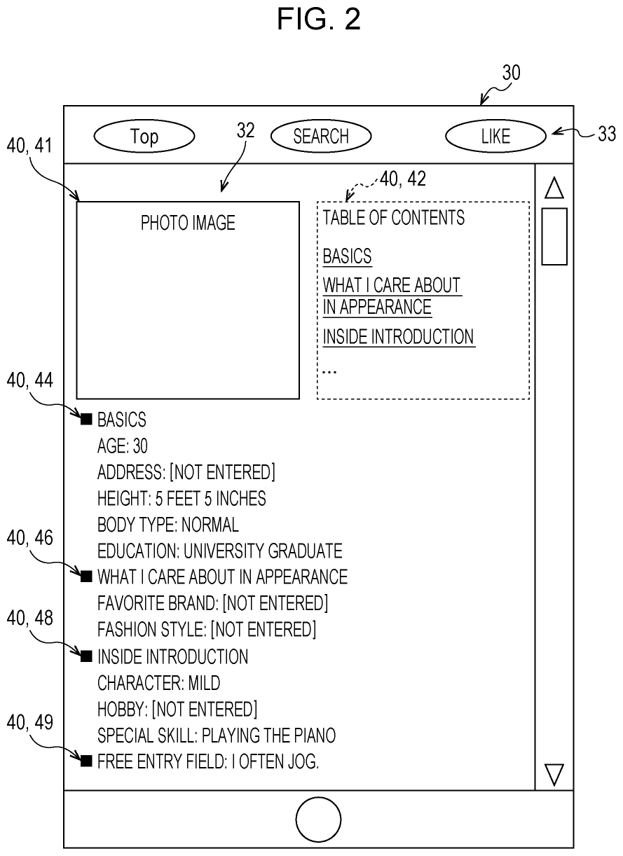

FIG. 2 schematically illustrates a display screen 30 displaying a profile 32. Referring to FIG. 2, the profile 32 includes multiple entries 40 indicating profile information. The entries 40 in the profile 32 includes a photo image 41, table of contents 42, basics 44, what I care about in appearance 46, inside introduction 48, and free entry field 49. The profile is not limited to the entries in FIG. 2 and may include lifelog or blog used for self-expression.

The photo image 41 is an entry 40 that indicates the face photo of a user who has registered the profile 32 (hereinafter also referred to as a registered user). The table of contents 42 indicates the headings of the entries 40. By selecting an entry 40 indicated in the table of contents 42, that entry 40 is displayed.

The basics 44 are the entry 40 indicating basic profile information on the registered user. For example, the basics 44 list the entries 40, such as the age, address, height, and education of the registered user. What I care about in appearance 46 is the entry 40 that indicates what the registered user cares about in appearance.

What I care about in appearance 46 may be the entries 40, such as the favorite brand, and fashion style of the registered user. The inside introduction 48 is the entry 40 that is used to introduce the inside of the registered user. For example, the inside introduction 48 include the entries 40 for the character, hobby, and special skills of the registered user. The free entry field 49 is the entry 40 that the registered user may write whatever he or she likes.

Each of the entries 40 in the profile 32 may be left blank. A blank entry 40 is denoted by an indication indicating that that entry 40 is left blank. The display screen 30 includes, separately from the profile 32, a screen portion 33 including a top button, search button, and like button.

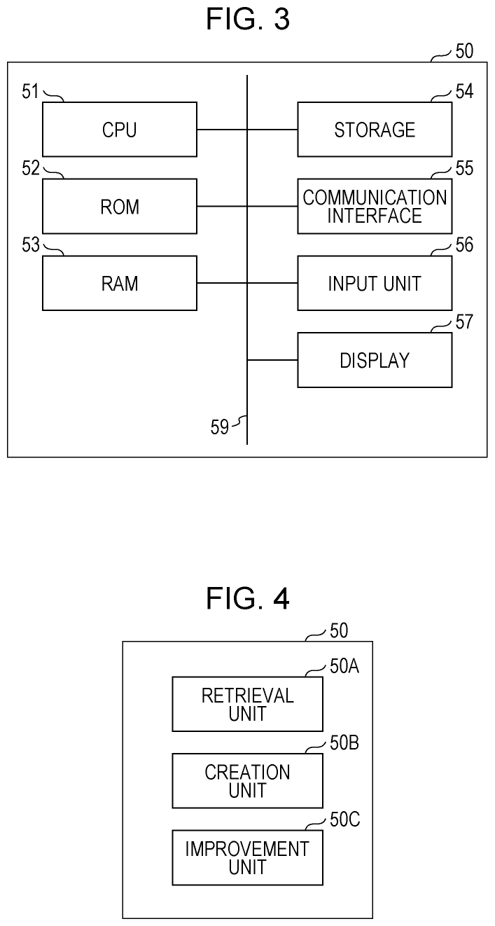

FIG. 3 is a block diagram of a hardware configuration of the server 50. The server 50 works as a computer. Referring to FIG. 3, the server 50 includes a central processing unit (CPU or processor) 51, read-only memory (ROM) 52, random-access memory (RAM) 53, storage 54, communication interface 55, input unit 56, and display 57. These elements in the server 50 are interconnected to each other via a bus 59.

The CPU 51 executes a variety of programs including a creation program and controls the elements of the server 50. Specifically, the CPU 51 reads a program from the ROM 52 or the storage 54 and executes the program using the RAM 53 as a working area.

The ROM 52 saves the programs and a variety of data. The RAM 53 works as the working area and temporarily saves the programs and data. The storage 54 may include a storage unit, such as a hard-disk drive (HDD) or a solid-state drive (SSD), and saves the programs including an operating system (OS) and the variety of data.

The communication interface 55 is used to communicate with another device, such as the device 20. The input unit 56 may include a pointing device, such as a mouse and/or a keyboard. The display 57 may be a liquid-crystal display and displays a variety of information. The display 57 may be of a touch-panel type. In such a case, the display 57 may also function as the input unit 56.

The server 50 uses the hardware described above to execute the programs, implementing the variety of functions. The functions implemented by the server 50 are described below. FIG. 4 is a functional block diagram illustrating the server 50 of the first exemplary embodiment.

Referring to FIG. 4, the server 50 includes a retrieval unit 50A, creation unit 50B, and improvement unit 50C. The CPU 51 implements the functions of these elements by reading and executing a creation program stored on the ROM 52 or the storage 54.

The retrieval unit 50A retrieves, from a retrieval destination linked with a provided service, activity information on a user who uses the provided service.

According to the first exemplary embodiment, the retrieval destination is a cooperation service linked with the provided service and saving activity information. Specifically, the coordination service is pre-linked with the provided service. For example, the cooperation service is a social networking service (SNS) that is pre-linked with the provided service and saves the activity information. According to the first exemplary embodiment, the retrieval unit 50A retrieves from the SNS the activity information concerning the activity of the user in the SNS.

The activity information relates to information on the user activity at the retrieval destination linked with the provided service. Specifically, the activity information is originated from the user.

For example, the activity information may be posted (uploaded) on the SNS by the user. Specifically, the activity information may include posted text and posted photo and position (place) indicated in the SNS.

The activity information does not include information on the user activity performed at a non-cooperation destination not linked with the provided service. According to the first exemplary embodiment, the activity information does not include log information on a log about which the user has simply browsed the SNS. The log information on the user browsing the SNS is not included to control noise (information that does not contribute to the creation of the profile information).

A user using the provided service may now apply for a registration of the profile 32 on the server 50 via the device 20. When the retrieval unit 50A has retrieved application information relating to the registration, the retrieval unit 50A retrieves the activity information on the user from the retrieval destination.

The retrieval unit 50B creates the profile information contained in the profile 32 in accordance with the activity information retrieved by the retrieval unit 50A. Specifically, the creation unit 50B creates the profile information indicating the contents of each entry 40 in the profile 32, in accordance with the information on the posted text and posted photo in the SNS and the information on the position (place) indicated in the SNS.

Using related art technique, such as morphological analysis, the creation unit 50B extracts from the posted text information for the creation of the profile information, and then creates the profile information. The creation unit 50B extracts information for the creation of the profile information, using related art technique, such as image recognition, and creates the profile information.

If a supplementable entry 40 is present in the profile, the improvement unit 50C improves the entry 40 with the created profile information. Specifically, if a blank entry item is present with the profile information unentered in the profile, the improvement unit 50C improves the blank entry item with the created profile information. The supplementing means filling a missing portion and does not mean resulting in a complete state.

If an insufficient entry item with a lack of entered profile information is present in the profile, the improvement unit 50C improves the insufficient entry item by linking the created profile information to the entered profile information. For example, if the profile information includes an insufficient entry item, information corresponding to the insufficient entry item is attached to the profile information. The improvement unit 50C may not necessarily improve the insufficient entry item by linking. For example, the improvement unit 50C may organize a separate display region and improve the insufficient entry item by displaying the information corresponding to the insufficient entry item in the separate display region.

If an inconsistent entry item with the entered profile information different from the created profile information is present in the profile, the improvement unit 50C improves the inconsistent entry item by substituting the created profile information for the entered profile information.

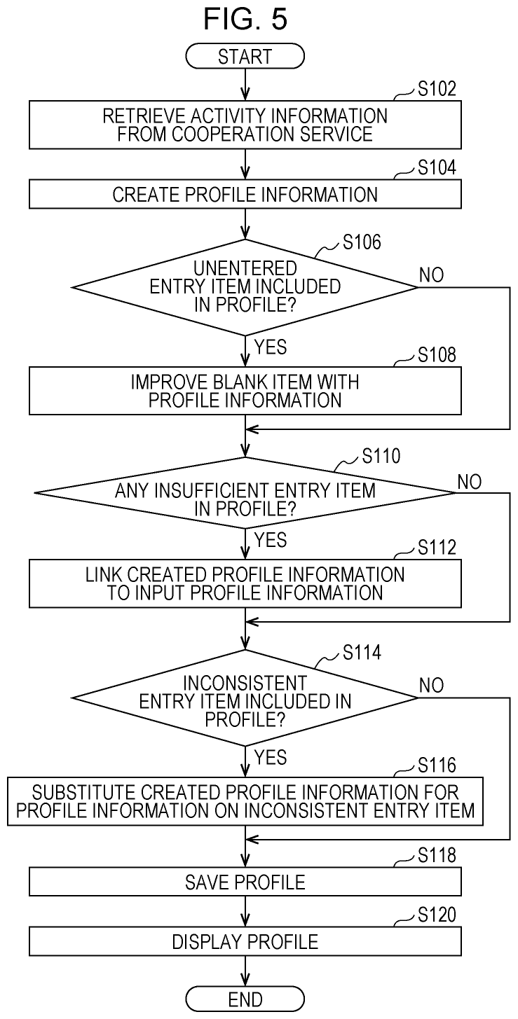

The creation process of the first exemplary embodiment is described below. FIG. 5 is a flowchart illustrating the creation process performed by the server 50.

The CPU 51 performs the creation process by reading and executing a creation program on the ROM 52 or the storage 54. The creation process is performed when a user applies a registration of the profile 32. The creation process may be performed before or after the user enters the profile information into each entry 40 of the profile 32.

Referring to FIG. 5, if the creation process is started, the CPU 51 first retrieves the activity information on the user who has applied the registration from the retrieval destination linked with the provided service (step S102). According to the first exemplary embodiment, the CPU 51 retrieves, as the activity information on the user in the SNS, the information on the posted text and photo in the SNS and the information on the position (place) in the SNS. According to the first embodiment, the SNS serving as the retrieval destination has been pre-linked with the provided service and the user having applied the registration has been registered.

The CPU 51 creates the profile information in the profile in accordance with the retrieved activity information (step S104). According to the first exemplary embodiment, the CPU 51 creates the profile information indicating the contents of each entry 40 of the profile 32, in accordance with the information on the posted text and photo in the SNS and the information on the position (place) in the SNS.

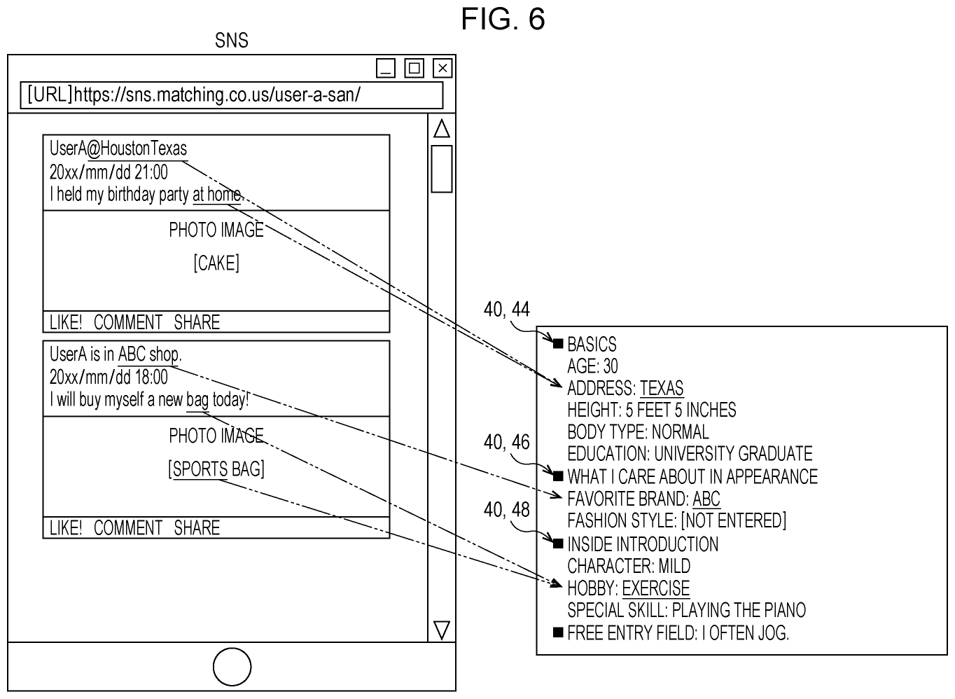

Specifically, referring to FIG. 6, the CPU 51 creates, from the position information indicated in the SNS, the profile information for the address in the basics 44 at the entry 40 in the profile 32. Based on the position information in the SNS, the CPU 51 creates the profile information for the favorite brand in what I care about in appearance 46 at the entry 40 in the profile 32. Based on the information on the posted text and photo, the CPU 51 further creates the profile information for the hobby in the inside introduction 48 at the entry 40. The profile information in the free entry field 49 may be a variety of information, including long-term information, such as a diary.

Referring to FIG. 5, the CPU 51 determines whether a supplementable entry 40 is present in the profile (see steps S106, S110, and S114). Specifically, in step S106, the CPU 51 determines whether a blank entry item is present in the profile.

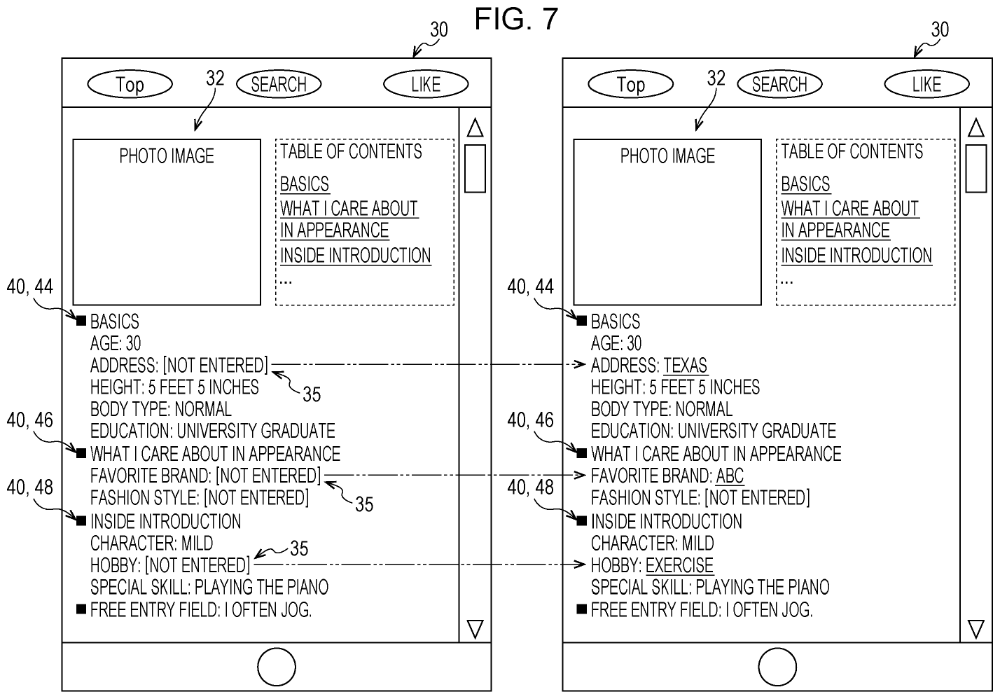

If the CPU 51 determines in step S106 that the profile includes a blank entry item (yes path from step S106), the CPU 51 improves the blank entry item with the created profile information as illustrated in FIG. 7 (step S108) and proceeds to step S110. Referring to FIG. 7, blank entry items 35 in the basics 44, what I care about in appearance 46, and the inside introduction 48 in the profile 32 are improved.

If the CPU 51 determines that no blank entry items are present in the profile 32 (no path from step S106), processing directly proceeds to step S110, not via step S108.

The CPU 51 determines in step S110 whether an insufficient entry item lacking information is present in the entered profile information in the profile 32.

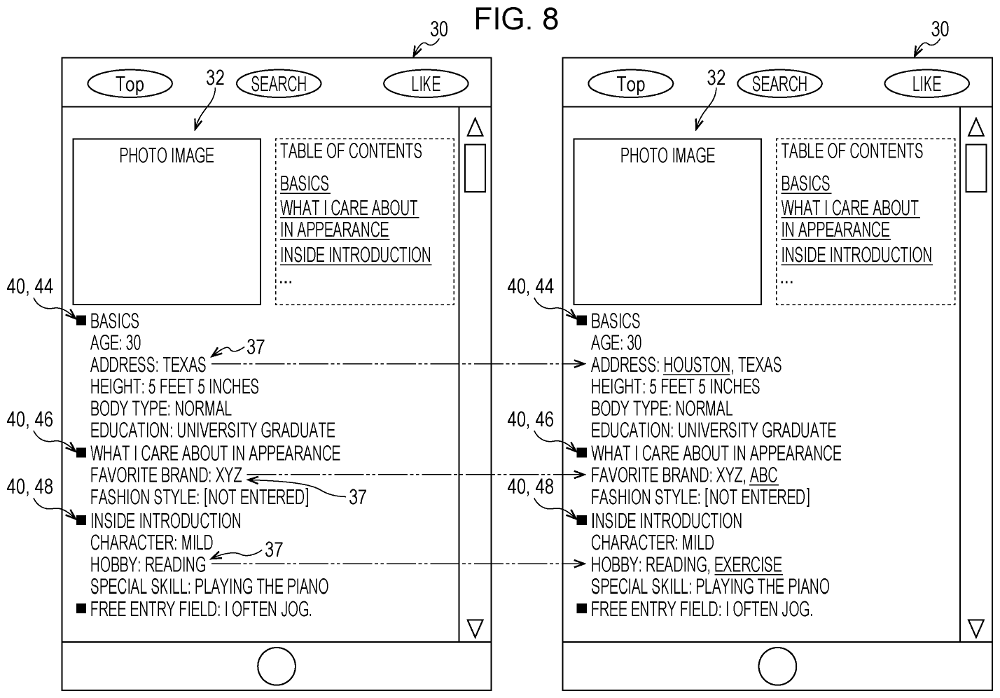

If the CPU 51 determines that the profile 32 includes an insufficient entry item (yes path from step S110), the CPU 51 improves the insufficient entry item by linking the entered profile information to the created profile information (step S112) and proceeds to step S114. Referring to FIG. 8, insufficient entry items 37 in the basics 44, what I care about in appearance 46, and the inside introduction 48 in the profile 32 are improved.

If the CPU 51 determines that no insufficient entry item is present in the profile 32 (no path from step S110), processing directly proceeds to step S114, not via step S112.

In step S114, the CPU 51 determines whether the profile 32 includes an inconsistent entry item where the entered profile information is different from the created profile information.

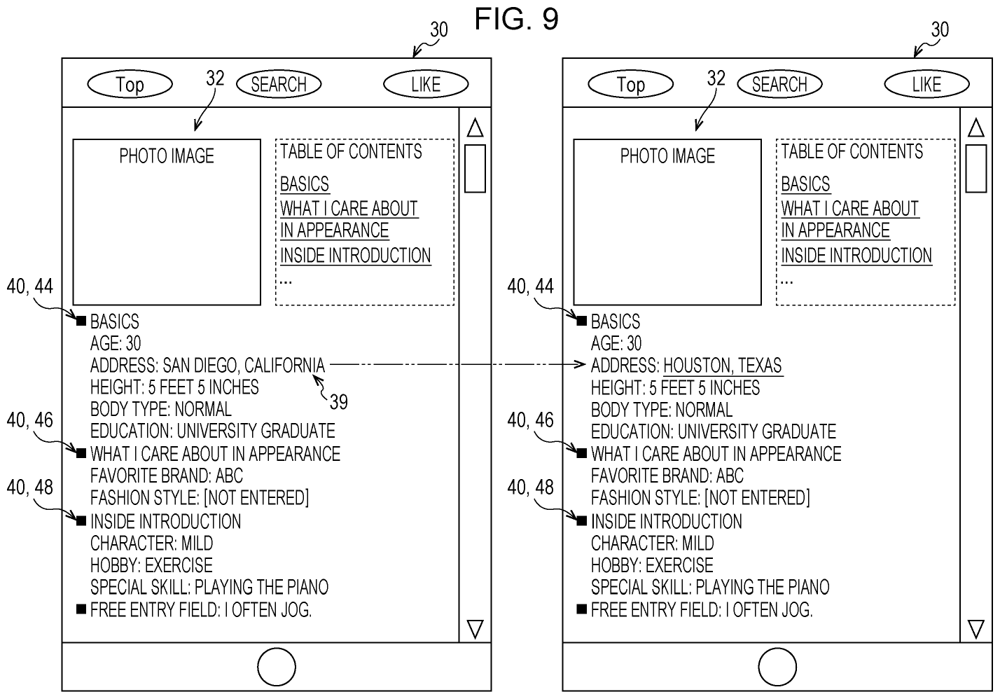

If the CPU 51 determines in step S114 that the profile 32 includes the inconsistent entry item (yes path from step S114), the CPU 51 improves the inconsistent entry item by substituting the created profile information for the profile information on the inconsistent entry item (step S116) and proceeds to step S11. Referring to FIG. 9, the insufficient entry item 39 in the basics 44 in the profile 32 are improved.

If the CPU 51 determines that the profile 32 includes no inconsistent entry item (no path from step S114), processing directly proceeds to S118, not via step S116.

In step S118, the CPU 51 saves the profile 32 on the storage 54. The CPU 51 displays the profile 32 to the user via the device 20 (step S120) and ends the process.

According to the first exemplary embodiment, the CPU 51 retrieves from the retrieval destination linked with the provided service the information on the activity of the user using the provided service and creates the profile information included in the profile 32 in accordance with the activity information retrieved by the CPU 51.

The user may thus display the contents of each entry 40 in the profile 32 using the created profile information. This arrangement takes less time for the user to enter the profile information than when the user enters all the profile information.

According to the first exemplary embodiment, if the profile 32 includes a supplementable entry 40, the CPU 51 improves the entry 40 with the created profile information. The contents of the profile 32 may be more enhanced than when the profile information at the supplementable entry 40 is left as is in the profile 32.

According to the first exemplary embodiment, if the profile 32 includes a supplementable entry 40, the CPU 51 automatically improves the entry 40 with the created profile information. The user takes less time to enter the profile information.

According to the first exemplary embodiment, if the profile 32 includes a blank entry item with the profile information not entered, the CPU 51 improves the blank entry item with the created profile information. The contents of the profile 32 may be more enhanced than when the profile information at only the entered entry 40 is improved.

According to the first exemplary embodiment, if the profile 32 includes an insufficient entry item lacking information in the entered profile information, the CPU 51 improves the insufficient entry item by linking the created profile information to the entered profile information. The contents of the profile 32 may be more enhanced than when only the blank entry item is improved.

According to the first exemplary embodiment, if the profile 32 includes an inconsistent entry item where the entered profile information is different from the created profile information, the CPU 51 improves the inconsistent entry item by substituting the created profile information for the entered profile information. The contents of the profile 32 are thus more enhanced than when the profile information at the entry 40 with the entered profile information different from the created profile information is left as is in the profile 32.

### Modifications

The exemplary embodiment includes the operations (steps S106 and S108) to improve the blank entry items if included in the profile 32, the operations (steps S110 and S112) to improve the insufficient entry items if included in the profile 32, and the operations (steps S114 and S116) to improve the inconsistent entry items if included in the profile 32. The disclosure is not limited to the process. All the operations described above are not necessarily included in the creation process of the exemplary embodiment. The creation process is enough if at least one of the operations described herein is performed.

According to the first exemplary embodiment, the server 50 automatically performs the operations (steps S106 through S116) to improve the created profile information. The disclosure is not limited to the process. For example, the server 50 may improve the created profile information at a supplementable entry item in the profile 32 in response to an instruction from the user.

According to the first exemplary embodiment, if the profile 32 includes a supplementable entry 40 after the profile information is created in accordance with the retrieved activity information (step S104), the entry 40 is improved with the created profile information (for example, steps S108 and S112). The disclosure is not limited to the process. For example, the CPU 51 determines if the profile 32 includes a supplementable entry 40, and if the CPU 51 determines that the profile 32 includes a supplementable entry 40, the CPU 51 may create the profile information for the entry 40 and improve the entry 40 with the created profile information. For example, the CPU 51 determines if the profile 32 includes a supplementable entry 40, and if the CPU 51 determines that the profile 32 includes a supplementable entry 40, the CPU 51 may retrieve from the retrieval destination the activity information relating to the entry 40, create the profile information relating to the entry 40, and improve the entry 40 with the created profile information.

The creation process of the first exemplary embodiment may be performed before or after the user enters the profile information at each entry 40 in the profile 32. Since all the entries 40 are empty before the user enters the profile information at each entry 40 in the profile 32, performing steps S106 and S108 is enough to improve the supplementable entry item in the profile 32. Steps S110 through S116 may be omitted.

In the case in which the creation process of the first exemplary embodiment is performed after the user enters the profile information at each entry 40 in the profile 32, the CPU 51 may enquire the user whether to perform the creation process and may perform the improvement operation in response to the execution instruction from the user. A determination as to whether to perform the improvement operation may be made in response to the input entered by the user to each entry 40 in the profile 32.

Before the improvement operations, the CPU 51 may enquire the user as to whether perform the improvement operation to improve the insufficient entry item (step S114) and the improvement operation to improve the inconsistent entry item (step S116). The CPU 51 may then perform the improvement operations in response to the execution instruction from the user. If the user has not given the instruction to perform the improvement operations, the CPU 51 keeps the profile 32 in the state prior to the improvement operations.

### Second Exemplary Embodiment

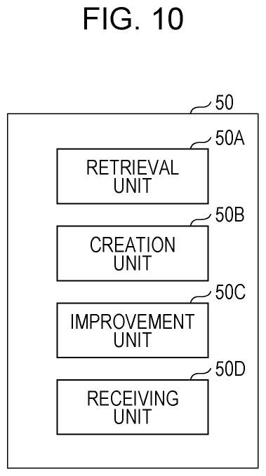

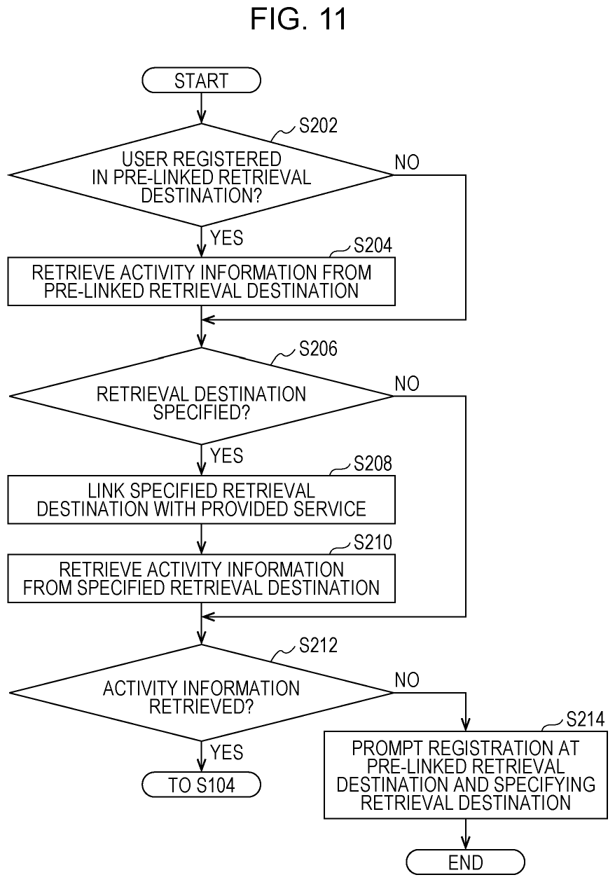

Second exemplary embodiment of the disclosure is described. FIG. 10 is a functional block diagram illustrating the server 50 of the second exemplary embodiment. FIG. 11 is a flowchart illustrating a creation process performed by the server 50 of the second exemplary embodiment. Elements identical to those in the first exemplary embodiment are designated with the same reference numerals and the discussion thereof are omitted herein as appropriate.

According to the second exemplary embodiment, the server 50 further includes a receiving unit 50D as illustrated in FIG. 10. The functions of the elements of the server 50 are implemented when the CPU 51 reads and executes a creation program saved on the ROM 52 or the storage 54.

The receiving unit 50D receives a designation of the retrieval destination linked with the provided service. Specifically, the receiving unit 50D receives via the device 20 designation information that specifies the retrieval destination. Upon receiving the designation information, the receiving unit 50D causes the specified retrieval destination to link with the provided service.

According to the second exemplary embodiment, the retrieval destination is the cooperation service linked with the provided service and saving the activity information. Specifically, the cooperation service may be a management service that manages usage information on portable devices of users (for example, wearable devices).

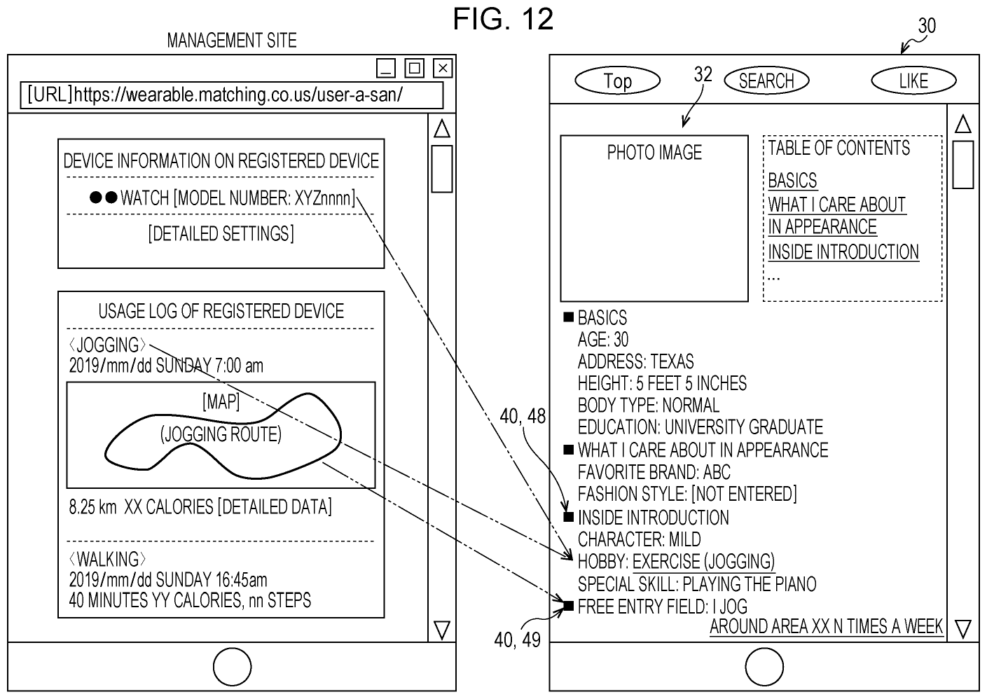

FIG. 12 illustrates a management site (for example, a web page) held by a management service that manages the usage information on the wearable device. Referring to FIG. 12, the management service saves device information on the wearable devices and usage logs.

The retrieval destination linked with the provided service may a retrieval destination specified by the user or a retrieval destination that is pre-linked with the provided service in the same manner as in the first exemplary embodiment.

The retrieval destinations set to link with the provided service include the management service and the cooperation service, such as the SNS (described in the first exemplary embodiment). The retrieval destinations are not limited to those services. The retrieval destination is enough if it saves the activity information. For example, The retrieval destinations include a service to register a user schedule, a service to use an email, such as an email to reserve a travel, a service to save and manage Internet articles and Internet pages, a service to learn the present position of the user or the like, for example, from the global positioning system (GPS), and a service to learn the location of the user through face recognition from images from a monitoring camera.

The profile information, for example, the hobby, the special skill, and what I care about in appearance at the entries 40 in the profile 32 may be created in accordance with the activity information that is retrieved from the service to register the user schedule, the service to use an email, such as an email to reserve a travel, and the service to save and manage Internet articles and Internet pages. The profile information, for example, the address at the entry 40 in the profile 32 may be created in accordance with the activity information that is retrieved from the service to learn the location of the user or the like.

The retrieval destination set to link with the provided service is not limited to the cooperation service set to link with the provided service. The retrieval destination set to link with the provided service may also be a device (cooperation device) set to link with the provided service and saving the activity information. The cooperation device may be a portable device carried by the user. The portable device may be a wearable device worn by the user. The wearable device may be of a writ-watch type, glasses type, ring type, shoe type, or pendant type. The profile information, such as the hobby (for example, a health-oriented hobby), the special skill, and what I care about in appearance at the entries 40 in the profile 32 may be created in accordance with the activity information from the wearable device.

According to the second exemplary embodiment, the retrieval unit 50A retrieves from the retrieval destination the activity information at the retrieval destination with which the receiving unit 50D has caused the provided service to link. If a retrieval destination pre-linked with the provided service is also present, the retrieval unit 50A may retrieve the activity information from both the retrieval destination with which the receiving unit 50D has caused the provided service to link and the retrieval destination pre-linked with the provided service. Alternatively, the retrieval unit 50A may retrieve the activity information only from the retrieval destination with which the receiving unit 50D has caused the provided service to link.

The process of the second exemplary embodiment is described below.

The process of the second exemplary embodiment is performed in place of the operation in step S102 of the first exemplary embodiment (see FIG. 5).

Referring to FIG. 11, the process may now be started and the CPU 51 determines whether the user having applied the registration is registered in the pre-linked retrieval destination (step S202).

If it is determined that the user having applied the registration is registered in the pre-linked retrieval destination (yes path from step S202), the CPU 51 retrieves from the pre-linked retrieval destination the activity information on the user who has applied the registration (step S204) and proceeds to step S206.

If it is determined that the user having applied the registration is not registered in the pre-linked retrieval destination (no path from step S202), the CPU 51 directly proceeds to step S206, not via step S204.

In step S206, the CPU 51 determines whether the retrieval destination has been specified by the user having applied the registration.

If it is determined that the retrieval destination has been specified by the user having applied the registration (yes path from step S206), the CPU 51 causes the specified retrieval destination to link with the provided service (step S208). The CPU 51 then retrieves the activity information on the user who has applied the registration from the specified retrieval destination (step S210) and proceeds to step S212. Referring to FIG. 12, the CPU 51 retrieves the device information and usage information on the wearable device from the management service.

If it is determined that the retrieval destination has not been by the user having applied the registration (no path from step S206), the CPU 51 directly proceeds to step S212 not via steps S208 and S210.

In step S212, the CPU 51 determines whether the activity information has been retrieved. If the CPU 51 determines that the activity information has been retrieved (yes path from step S212), the CPU 51 proceeds to step S104 (see FIG. 5).

In step S104, the CPU 51 creates the profile information in the profile 32 in accordance with the retrieved activity information (step S104). Referring to FIG. 12, based on the device information on the wearable device, the CPU 51 creates the profile information at the entry 40 for the hobby in the inside introduction 48 in the profile 32. For example, the CPU 51 creates the profile information at the free entry field 49 from the usage log of the wearable device.

If it is determined that the activity information has not been retrieved (no path from step S212), the CPU 51 ends the process by prompting the user to register in the pre-linked retrieval destination and specify the retrieval destination (step S214). In step S212, the CPU 51 displays a message “Please register in the pre-linked retrieval destination or specify the retrieval destination”.

According to the second exemplary embodiment, the activity information is retrieved from the specified retrieval destination and the profile information is created based on the activity information. The contents of the profile 32 are more enhanced than when the activity information is retrieved from only the cooperation service pre-linked with the provided service.

### Modifications

According to the second exemplary embodiment, when the user has applied the registration of the profile 32 on the provided service, the user may be prompted to register in the pre-linked retrieval destination and specify the retrieval destination. For example, the CPU 51 may display the message “Please register in the pre-linked retrieval destination or specify the retrieval destination”.

According to the second exemplary embodiment, the operations in steps S202 and S204 in FIG. 11 may be omitted if there is no retrieval destination pre-linked with the provided service.

According to the second exemplary embodiment, the specified retrieval destination may be linked with the provided service after verifying that the specified retrieval destination is a reliable information source. The reliability of the retrieval destination is determined based on the system or service linked with the retrieval destination. Specifically, if the system or service to be linked with the retrieval destination is provided by a public agency, the reliability may be considered higher.

### Third Exemplary Embodiment

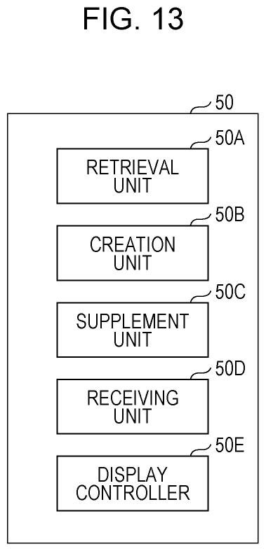

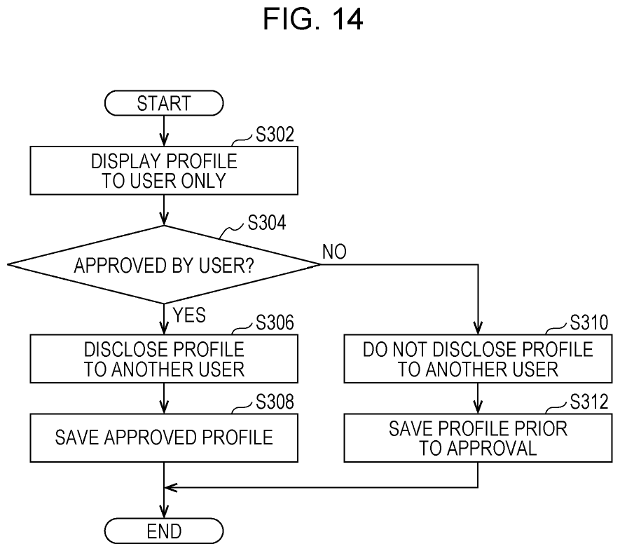

Third exemplary embodiment is described below. FIG. 13 is a functional block diagram illustrating a server 50 of a third exemplary embodiment. FIG. 14 is a flowchart illustrating a creation process performed by the server 50 of the third exemplary embodiment. Elements identical to those in the first exemplary embodiment are designated with the same reference numerals and the discussion thereof is omitted as appropriate.

According to the third exemplary embodiment, the server 50 further includes the receiving unit 50D and display controller 50E as illustrated in FIG. 13. The functions of the elements are implemented when the CPU 51 reads a creation program saved on the ROM 52 or the storage 54.

The display controller 50E displays to only a user the profile information created by the creation unit 50B. The user herein corresponds to the created profile information and discloses the profile information to another user. Specifically, the display controller 50E displays to only the user the profile, which the improvement unit 50C improves with the profile information, via the device 20 identified as a device 20 to be used by the user.

The memory, such as the RAM 53 in the server 50, temporarily saves the profile that the improvement unit 50C improves with the profile information and the display controller 50E displays the profile.

The display controller 50E displays the created profile information together information indicating that the profile information is a piece of created information (hereinafter referred to as creation information). Specifically, according to the third exemplary embodiment, the creation information indicates that the creation information is the profile information improved by the improvement unit 50C.

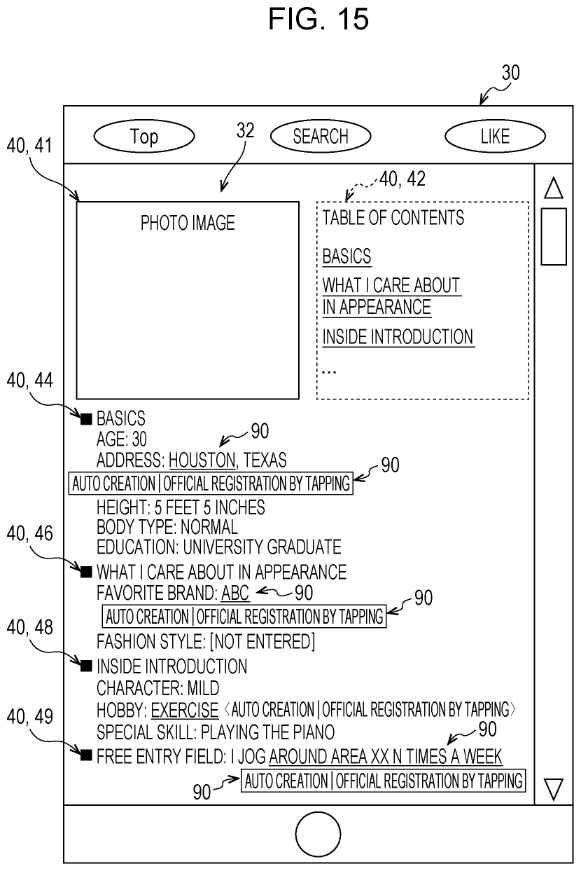

Referring to FIG. 15, the creation information is an identifier 90 attached to the created profile information (for example, a tag, underline, or character). Referring to FIG. 15, the underline and “Auto creation|official registration by tapping” are attached as the identifier 90 to the created profile information. The creation information may be highlighted by changing the color or size of characters indicating the profile information or reversing video between the background color and character color.

The display controller 50E displays the created profile information in a way different from the profile information entered by the user.

The receiving unit 50D receives an approval for the contents of the profile information displayed by the display controller 50E. Specifically, the receiving unit 50D receives approval information indicating the contents of the profile information approved by the user via the device 20. Referring to FIG. 15, if a portion of “Auto creation|official registration by tapping” is selected (tapped), the receiving unit 50D receives the approval for the contents of the profile information.

If the profile information is approved by the user, the display controller 50E discloses the profile information to another user. Specifically, if the receiving unit 50D receives the approval information indicating the approval for the contents of the profile information, the profile information may be displayed to the other user via the device 20. For example, the other user may be a user who views the profile information on the first user or a user who may match the first user.

The process of the third exemplary embodiment is described below.

The process of the third exemplary embodiment is performed in place of the operations in steps S118 and S120 in the process of the first exemplary embodiment (see FIG. 5).

As illustrated in FIG. 14, the process may now be started. The CPU 51 displays the created profile information to only the user (step S302). According to the third exemplary embodiment, the created profile information is displayed together with the creation information. Specifically, referring to FIG. 15, the under line and the characters “Auto creation|official registration by tapping” are attached as the identifier 90 to the created profile information.

The CPU 51 determines whether the approval for the contents of the profile information has been received (step S304). If it is determined that the approval for the contents of the profile information has been received (yes path from step S304), the profile information is displayed to another user (step S306). Specifically, the CPU 51 sets the contents of the profile information approved by the user to be displayable to the other user via the device 20.

Referring to FIG. 15, if the characters “Auto creation|official registration by tapping” are selected (touched), the CPU 51 receives the approval for the contents of the profile information. The CPU 51 saves the profile having the contents approved by the user on the storage 54 (step S308).

If it is determined that the approval for the contents of the profile information has not been received (no path from step S304), the CPU 51 does not disclose the profile information to the other user (step S310). The CPU 51 saves the profile having the contents prior to user approval on the storage 54 (step S312).

According to the third exemplary embodiment, the created profile information is displayed to only the user. The user may thus check the contents of the created profile information without the other users noticing it.

According to the third exemplary embodiment, the created profile information is displayed together with the creation information. The user may differentiate the created profile information from the entered profile information more easily.

According to the third exemplary embodiment, the profile information is disclosed to another user via the device 20 if the approval information approving the contents of the profile information is received. This arrangement controls the opportunity that the profile information not checked by the user is disclosed to the other users.

### Modifications

According to the third exemplary embodiment, when the created profile information is displayed only to the user, the created profile information is displayed together with the creation information. The disclosure is not limited to this arrangement. When the created profile information is disclosed to the other users, the created profile information is also displayed together with the creation information. In another arrangement, the creation information may be displayed to only the other users.

The third exemplary embodiment is applied to business matching service. In a service recruiting new graduates, the hobby and special skill of a user may be entered as a profile during service registration. In such a case, the profile information about the hobby and special skill of the user may be reflected on the profile as described with reference to the exemplary embodiments. In a service assisting changing jobs, the name of a company and work style may be entered in a profile. In such a case, the activity information on the user is retrieved using a wearable terminal and the position information on the terminal. Information on a former job, such as the location of the company, and the work style involving going out or desk work, is reflected on a profile.

In the exemplary embodiments above, the term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A creation apparatus comprising
a processor configured to
retrieve, from a retrieval destination linked with a service, activity information on a user who uses the service in which a profile of the user is registered, and
create, in accordance with the activity information, profile information to be included in the profile.

2. The creation apparatus according to claim 1, wherein the professor is configured to, if the profile includes a supplementable entry item, improve the supplementable entry item with the created profile information.

3. The creation apparatus according to claim 2, wherein the professor is configured to, if the profile includes an entry item into which the profile information has not been entered, improve the entry item with the created profile information.

4. The creation apparatus according to claim 2, wherein the professor is configured to, if the profile includes an entry item where the entered profile information is insufficient, improve the entry item by attaching the created profile information to the entered profile information.

5. The creation apparatus according to claim 3, wherein the professor is configured to, if the profile includes an entry item where the entered profile information is insufficient, improve the entry item by attaching the created profile information to the entered profile information.

6. The creation apparatus according to claim 2, wherein the professor is configured to, if the profile includes an entry item where the entered profile information is different from the created profile information, improve the entry item by substituting the created profile information for the entered profile information.

7. The creation apparatus according to claim 3, wherein the professor is configured to, if the profile includes an entry item where the entered profile information is different from the created profile information, improve the entry item by substituting the created profile information for the entered profile information.

8. The creation apparatus according to claim 4, wherein the professor is configured to, if the profile includes an entry item where the entered profile information is different from the created profile information, improve the entry item by substituting the created profile information for the entered profile information.

9. The creation apparatus according to claim 5, wherein the professor is configured to, if the profile includes an entry item where the entered profile information is different from the created profile information, improve the entry item by substituting the created profile information for the entered profile information.

10. The creation apparatus according to claim 1, wherein the processor is configured to receive a designation of the retrieval destination linked with the service and configured to retrieve the activity information from the retrieval destination.

11. The creation apparatus according to claim 2, wherein the processor is configured to receive a designation of the retrieval destination linked with the service and retrieve the activity information from the retrieval destination.

12. The creation apparatus according to claim 3, wherein the processor is configured to receive a designation of the retrieval destination linked with the service and retrieve the activity information from the retrieval destination.

13. The creation apparatus according to claim 4, wherein the processor is configured to receive a designation of the retrieval destination linked with the service and retrieve the activity information from the retrieval destination.

14. The creation apparatus according to claim 5, wherein the processor is configured to receive a designation of the retrieval destination linked with the service and retrieve the activity information from the retrieval destination.

15. The creation apparatus according to claim 6, wherein the processor is configured to receive a designation of the retrieval destination linked with the service and retrieve the activity information from the retrieval destination.

16. The creation apparatus according to claim 1, wherein the processor is configured to display the created profile information to only a user who corresponds to the profile information.

17. The creation apparatus according to claim 16, wherein the processor is configured to display the created profile information together with information indicating that the created profile information is a piece of created information.

18. The creation apparatus according to claim 16, wherein the processor is configured to receive an indication of an approval for contents of the displayed profile information and disclose the profile information to another user viewing the profile information if the indication of the approval has been received.

19. The creation apparatus according to claim 17, wherein the processor is configured to receive an indication of an approval for contents of the displayed profile information and disclose the profile information to another user viewing the profile information if the indication of the approval has been received.

20. A non-transitory computer readable medium storing a program causing a computer to execute a process for creating profile information, the process comprising:
retrieving, from a retrieval destination linked with a service, activity information on a user who uses the service in which a profile is registered, and
creating, in accordance with the activity information, the profile information to be included in the profile.
